(19) United States
(12) Patent Application Publication
(10) Pub. No.: US 2008/0113676 A1
(43) Pub. Date: May 15, 2008

(54) Rapidly deployable communications system

(75) Inventors: Joel Hutton, Lewisville, TX (US); Matthew Seppeler, Lewisville, TX (US); Dan Hilz, Lewisville, TX (US)

Correspondence Address: STRASBURGER & PRICE, LLP, 901 MAIN STREET, SUITE 4400, DALLAS, TX, 75202, US

(73) Assignee: INX Inc.

(21) Appl. No.: 11/732,034

(22) Filed: Apr. 2, 2007

Related U.S. Application Data
(63) Continuation of application No. 11/595,345, filed on Nov. 9, 2006, now abandoned.

(51) Int. Cl. H04Q 3/00

(52) U.S. Cl. 455/461

(57) ABSTRACT

A communications node for use in forward areas includes a hardened housing. Within the hardened housing are modules which transform communication in a first protocol to communication in a second protocol. Power is supplied to the communication modules by any one of a variety of power sources available in the forward area. The modules may be exchanged in the forward area. The modules may be exchanged or replaced in the housing without the use of tools.

### CROSS REFERENCE TO RELATED APPLICATION

This application claims the benefit of Provisional U.S. Patent Application No. 60/735,106 filed Nov. 9, 2005 and is a continuation of U.S. patent application Ser. No. 11/595,345 filed Nov. 9, 2006, now abandoned.

### STATEMENT REGARDING FEDERALLY FUNDED RESEARCH AND DEVELOPMENT

The invention described in this patent application was not the subject of federally sponsored research or development.

### FIELD

The present invention pertains to communications systems; more particularly, the present invention pertains to a hardware/software package for communications systems that can be used by the military in forward areas and to a hardware/software package for communications systems that can be used by first responders and emergency personnel to re-establish communications when fixed systems are non-existent or have been compromised/destroyed. Also, the present invention is usable in any area that does not have a traditional communications infrastructure; for example, oil and gas drilling and production sites, construction sites, rural/remote areas, etc.

### BACKGROUND

The tragedies which have befallen the United States, such as the attacks of Sep. 11, 2001 and hurricanes Katrina and Rita in 2005 which struck the Gulf Coast Region, underline the need for a communications system which can be established rapidly to save lives and minimize damage. However, post-event investigations often reveal that first responders, emergency personnel, and even military units have not been in communication with one another, even when they are in close physical proximity. For example, it was reported that firemen were not able to communicate with policemen near the scene of the Sep. 11, 2001 attacks in New York City. In the Gulf Coast Region, policemen, particularly those from small towns using radios purchased decades ago, were not able to communicate with National Guardsmen. In some combat situations, soldiers from the Army have not been able to communicate with Marines, Sailors, Coast Guardsmen, or Airmen, even when the Marines, Sailors, Coast Guardsmen, or Airmen are clearly visible to each other and can provide badly needed support to one another. In other combat situations, the incompatibility of communication systems used by forces from multiple nations has prevented badly needed coordination of ongoing operations.

The technical incompatibility of the electrical format or message protocols used in communications systems is often given as the reason that units or personnel in close proximity to one another cannot communicate with each other. Specifically, military units may have advanced digital communications systems, while local law-enforcement personnel may still be using outdated analog communications equipment. Others may only have either land-line or cellular telephone appliances. Still others may only have voice capabilities when there is a need to transmit or receive data and/or video. And still others do not have access to Internet Protocol (IP) type communications.

While it is true that first responders, emergency personnel, and the military do have different communications systems, modern software systems are presently available to bridge the gaps to enable communication between many different communications systems. Such systems include both hardware and software that can receive a video, voice, or data signal, convert that electrical signal into another format or message protocol; for example IP, and then send the converted electrical signal out for re-transmission in the converted format or message protocol. Unfortunately, the hardware and software for such video, voice, or data communication system conversion is complex and often quite delicate. Thus, such hardware and software systems for receiving and re-transmitting voice, data or video signals are typically located in buildings having dust-free, temperature-controlled, and humidity-controlled environments.

Accordingly, a need remains in the art for a system that can be quickly taken to remote areas to place the hardware and software systems that enable video, voice, or data communication systems to communicate with one another into environments in which first responders, emergency personnel, and the military can communicate with each other. Further, not only must first responders, emergency personnel, and the military be able to communicate with each other, but these personnel should also be able to gain access to even larger communication networks to gain access to other personnel and needed video, voice, or data networks available through any communications systems.

The earthquake which rocked Pakistan in 2005 provides a recent practical example of how communication compatibility can be used to assist disaster victims. To reach victims of the earthquake, the U.S. deployed combat helicopters stationed in nearby Afghanistan to Pakistan. These combat helicopters came from multiple branches of the U.S. Armed Forces; but their missions into remote areas were coordinated by a single ground flight operations station. The ground flight operations station used information gained from first responders and emergency personnel to determine where lives needed to be saved, roads needed to be cleared, or special equipment, such as fire-fighting gear, was required.

Unfortunately, in domestic situations presently available video, voice, or data communications systems do not allow effective communication between all those involved in disaster relief operations. For example, a first responder using a cellular telephone or land-line telephone may not be able to communicate with the pilot of a military helicopter hovering overhead to reach rescue victims. Further, communications between the pilots of rescue helicopters and location aids, such as an Internet website providing detailed photos of devastated areas, cannot be enabled because of the lack of communication nodes where multiple communications systems can be brought together and then made to communicate with each other using sophisticated hardware and software systems.

Accordingly, there remains a need in the art for a communications node that can be rapidly deployed to remote areas and then used in the remote location to assure that communications systems, heretofore incompatible, can communicate with one another.

### SUMMARY

The disclosed compact, self-contained communications node systems can be rapidly deployed and used anywhere to assure that video, voice, and data communications systems heretofore incompatible can communicate with one another, and/or to extend the voice/video/data systems to remote environments with or without the interoperable communications. Specifically, electrical communications signals according to one of a set of anticipated first message protocols are transformed into one of a set of second message protocols reasonably expected to be found in a forward area.

The local or forward area rugged communications node portion of the disclosed communications system is light-weight, pre-configured, and self-contained. Near instantaneous local area voice video and data communications capability is provided. Power for the forward area rugged communications node is provided by any one of a variety of AC or DC electrical sources, such as commercial power, generator power, or a truck/aircraft battery. Power input can also be managed to remove any detectable electrical signature for stealth communication in a combat environment.

In the preferred embodiment, wired and wireless (802.11) Local Area Network operations are provided. However, with the appropriate connectivity, Wide Area Network services can be provided for connectivity back to a command center, headquarters location, or some other fixed installation effectively anywhere in the world.

### BRIEF DESCRIPTION OF DRAWING FIGURES

A still better understanding of the rapidly deployable communications system of the present invention may be had by reference to the drawing figures wherein:

FIG. 1 is a perspective view of the disclosed invention;

FIG. 2 is a view similar to FIG. 1 but with lid opened;

FIG. 3 is a perspective view of the components located within the housing;

FIG. 4 is another perspective view, from the opposite end, of the components within the housing.

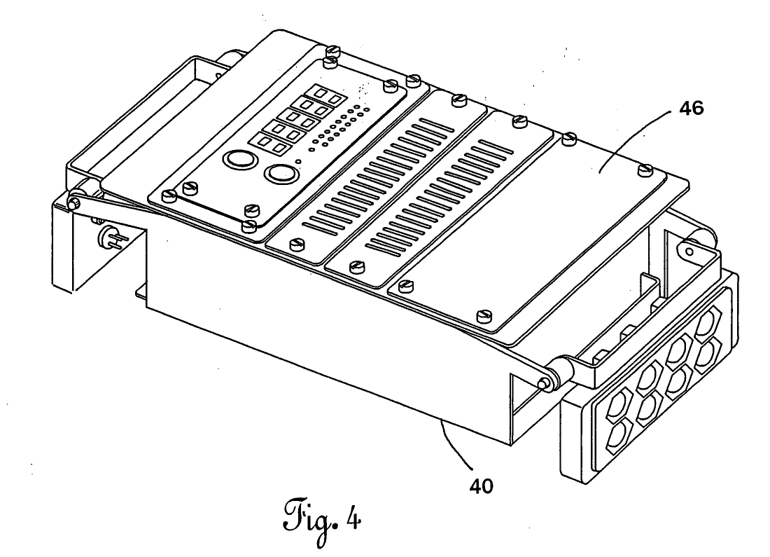

### DESCRIPTION OF THE EMBODIMENTS

In the military setting, a local or forward area communications node is provided for each rifle platoon to facilitate communications with other rifle platoons, infantry company command headquarters and attached units within an infantry company area of operations.

Users of the disclosed invention 10 can attach to a variety of communication capabilities to include:
a) satellite communication: IP or ISDN-based terminals enabling IP-based communication as well as synchronous and asynchronous serial communications;
b) data cellular communication: commercial carriers and a GPS receiver capabilities;
c) wireless communication: integrated FCC licensed 4.9 GHz and/or 801.22 b/g;
d) synchronous and asynchronous serial communications: frame relay, CSU/DSU for T1/E1.

On a preferred embodiment up to twelve 10/100 Ethernet (RJ45) ports to attach to a wide variety of network communication devices including ISDN or IP-based satellite terminals, cellular data modems, or 802.11 wireless bridges or access points are available.

Also available are serial ports for synchronous and asynchronous communications connections.

WAN connection options include 802.11 b/g wireless, 4.9 GHz wireless, satellite, cellular (1×RTT, GSM, etc.) DSL/Cable modem, T1/E1, and ISDN.

Options that the disclosed local or forward area communications node provides include GPS, Type-1 encryption, PC server hardware and mobile GSM base stations. Fiber connectivity can be added as well as vial media converters.

The network interfaces allow seamless local communications with a variety of devices, including wired or wireless IP phones, IP video surveillance cameras, GSM voice and data devices, and laptop computers, as well as WAN connectivity via satellite, 802.11 wireless bridging, and cellular networks. In addition any IP service available on a home network can be made available to include voice, video and data.

Operators of the disclosed communication node 10 can establish the desired seamless connectivity by simply attaching the communications node to an available source of electrical power to include a cigarette lighter, turning on the power, and deploying wired phones, wireless phones, radios, laptops and other communication devices. Universal auto-sensing power supplies contained within one of the ruggedized model provide for hookup to most any source of either residential or electrical power from 10-32 volts DC or 85-240 volts AC where a predetermined type of vehicle is to be used vehicle specific power outlet cables and connectors can be made available to assure physical compatibility with available sources of electrical power.

Internal software embedded in the circuitry automatically detects the best available network for communication and discretely changes its connections without disruption to existing network communications. Accordingly, the disclosed local or forward area communications node 10 can be used on a moving vehicle or aircraft for seamless video, voice and data communications.

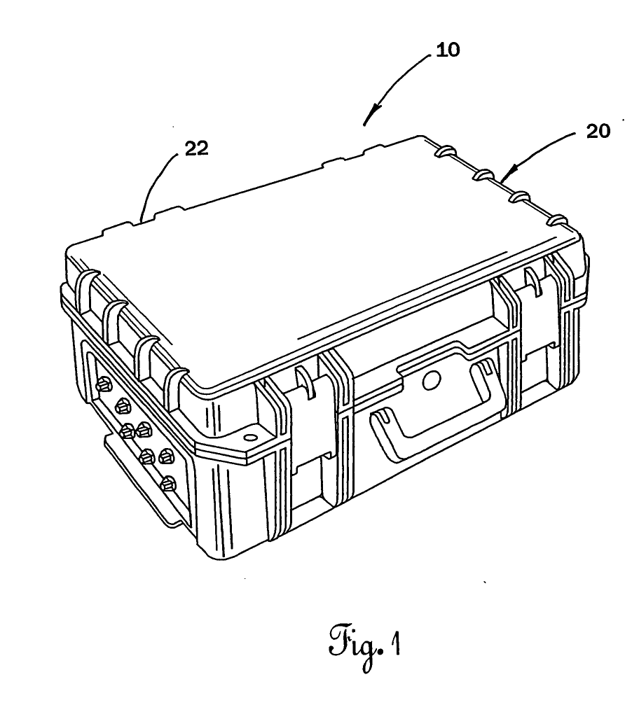

Because of the dust-resistant, moisture-resistant, and crush-resistant case hardened assembly 20 enclosing the internal mounting for the electronic componentry as shown in FIG. 1, the disclosed local or forward area communications node 10 can withstand the rough handling and extreme conditions characteristic of field operations. External ports 30 are equipped with dust-proof, moisture-proof caps.

A still better understanding of the local communications node may be had from the drawing figures. FIG. 1 is a perspective of the communications node 10. The size and weight meets carry-on luggage restrictions to allow for transportation on commercial aircraft. Optionally included are pull out handles and in-line wheels of the type often found on most personal suitcases. For ease of transport, the communications nodes 10 are easily stackable one upon another either in the back of a truck or in the cargo hold of an aircraft.

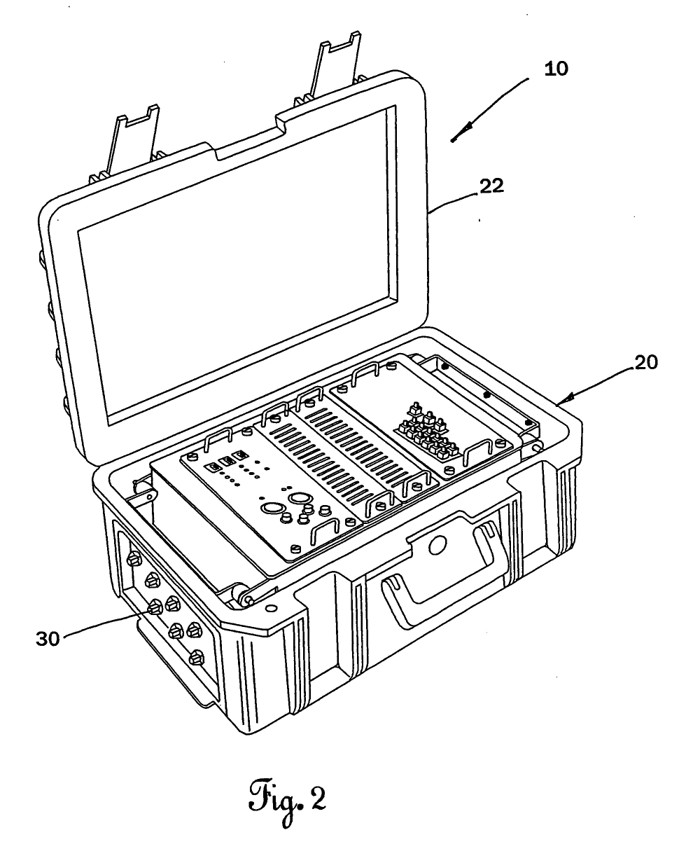

FIG. 2 is a front left perspective view of the set of internal componentry 40 removed from the ruggedized case.

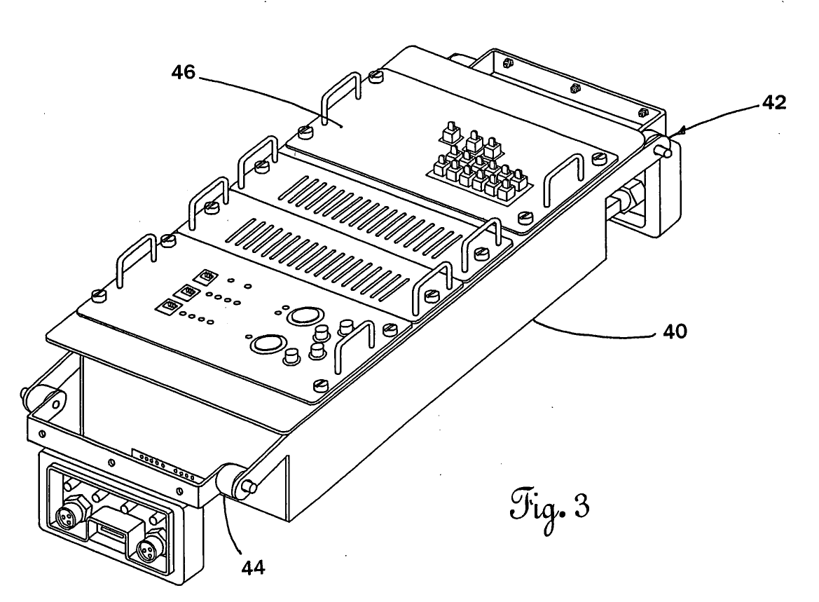

FIG. 3 is a front right perspective view of the componentry 40. Within the ruggedized case is a modular chassis assembly 42 on a shock-resistant rack 44 to protect the hardened electronic modules 46 within the case 20.

The local or forward area communications node 10 is also constructed to be serviceable without the use of sophisticated tools. Each section of the local communications node is constructed as a hardened module 46 which can only be inserted into the case in one way. The connecting circuitry and plugs for the connecting modules are included within the case. Quarter-turn or finger turnable fasteners or standard screwdriver-turned fasteners and pull handles are used to facilitate removal and replacement of the hardened electronic modules 46.

The electronic componentry has a shock-resistant mounting, as shown in FIGS. 2 and 3, to allow its operation in a vehicle traveling down bumpy roads or in an aircraft flying in choppy weather.

All electrical componentry has been selected to allow operation in normally anticipated temperature ranges from about −40° C. to about +70° C. or higher and in a relative humidity from about 10% to about 95%. Air filters, preferably oil based air filters and optionally ruggedized fans well known to those of ordinary skill in the art assure clean and quiet ventilation when the forward area communications node 10 is in operation with the cover 22 in place.

Multiple receptacles for receiving either power cabling or communications cabling conforming to all expected standards or protocols are provided so that mechanical connectivity is not an obstacle to the utility of the local or forward area communications node 10.

While the disclosed local communications node may be configured for WAN utility, it is expected that numerous local communications nodes 10 will be deployed in a forward area, such as with the rifle platoons in an infantry company. Each of these local or forward area communications nodes 10 may be in contact with other similar forward area communications nodes 10 located with an infantry company commander or larger forward area communications nodes located, for example, at the infantry battalion or infantry brigade level. The disclosed forward area communications node 10 is constructed for operation in a field environment where power, communications systems, HVAC, and potable water are not available either because of the remoteness of the location or because such services have been destroyed by a natural or man-made calamity.

In operation, the forward area communications node can be located in a temporary shelter, in a stationary or moving ground vehicle or in a stationary or moving aircraft.

While the disclosed communications node has been disclosed according to its preferred embodiment, those of ordinary skill in the art will understand that other embodiments have been enabled by the foregoing disclosure. Such embodiments shall be included within the scope and meaning of the appended claims.

What is claimed is:

1. A system for providing connectivity between voice/data/video communications systems comprising:
a hardened housing;
modularized circuitry within said hardened housing for receiving a communication signal according to a first protocol and transforming it into a communication signal for a second protocol;
a power supply for said circuitry capable of receiving input electrical power from a variety of different sources and transforming said input electrical power into the power required by said modularized circuitry;
selected components that reduce the need for auxiliary heating and cooling;
wherein traditional communications networking services and mobile data center capabilities are provided in a highly portable and environmentally hardened package.

2. The system as defined in claim 1 wherein said hardened housing includes at least one fan and air filter.

3. The system as defined in claim 1 wherein said modularized circuitry selects a communication network for transforming a communication signal from a first protocol to a second protocol.

4. The system as defined in claim 1 wherein said modularized circuitry allows for encrypted communication.

5. The system as defined in claim 1 wherein said power supply includes an array of connectors for connection to a variety of different sources of electrical power.

6. The system as defined in claim 1 wherein said modularized circuitry is replaceable without the use of tools.

7. The system as defined in claim 1 wherein said modularized circuitry will only fit within said hardened housing in one way.

8. The system as defined in claim 1 wherein said modularized circuitry is mounted in a shock resistant rack.

9. A communications node for providing interoperability between voice/data; video communications systems, said communications node comprising:
a hardened housing assembly having an openable cover;
a modularized power supply constructed and arranged to be connected to a variety of available power supplies;
at least one modularized circuit constructed and arranged for mounting within said hardened housing assembly for transforming a communications signal from a first protocol to a second protocol, said at least one modularized circuit having an array of connections for connections to a variety of communication inputs and outputs.

10. The communications node as defined in claim 9 wherein said modularized power supply is constructed and arranged to prevent the emission of a detectable electrical signature.

11. The communications node as defined in claim 9 wherein said modularized power supply automatically shifts between available source of electrical power.

12. The communications node as defined in claim 9 wherein said communications signal includes encrypted information.

13. The communications node as defined in claim 9 wherein said at least one modularized circuit is replaceable in said hardened housing without the use of tools.
